(19) United States
(12) Patent Application Publication
(10) Pub. No.: US 2026/0167107 A1
(43) Pub. Date: Jun. 18, 2026

(54) GLARE SENSING FOR REARVIEW MIRROR ASSEMBLY

(71) Applicant: Gentex Corporation, Zeeland, MI (US)

(72) Inventors: Richard T. Fish, JR., Hudsonville, MI (US); Eric S. Lundy, Holland, MI (US); Michael F. Lisowski, Holland, MI (US)

(73) Assignee: Gentex Corporation, Zeeland, MI (US)

(21) Appl. No.: 19/419,352

(22) Filed: Dec. 15, 2025

Related U.S. Application Data
(60) Provisional application No. 63/734,814, filed on Dec. 17, 2024.

(51) Int. Cl. B60R 1/08; B60R 1/04; B60R 1/12

(52) U.S. Cl. CPC B60R 1/088; B60R 1/04; B60R 1/12; B60R 2001/1223

(57) ABSTRACT

A rearview mirror assembly includes an assembly housing and a connection member extending from a first end coupled to the assembly housing and a second end configured to be coupled to a vehicle interior. An optical stack is coupled to the assembly housing and includes an electro-optic element configured to switch between a substantially transmissive state and a substantially darkened state based on an applied voltage. A printed circuit board (“PCB”) is located within the connection member and in conductive communication with the electro-optic element for selectively transmitting the applied voltage. The rearview mirror assembly further includes a first light sensor and a light guide pipe. The light guide pipe includes a first guide end located in the assembly housing and proximate the optical stack and a second guide end located proximate the first light sensor, and the light guide pipe extends at least partially through the connection member.

### CROSS-REFERENCE TO RELATED APPLICATION

This application claims priority to and the benefit under 35 U.S.C. § 119(e) of U.S. Provisional Application No. 63/734,814, filed on Dec. 17, 2024, entitled “GLARE SENSING FOR REARVIEW MIRROR ASSEMBLY,” the disclosure of which is hereby incorporated herein by reference in its entirety.

### FIELD OF THE DISCLOSURE

The present disclosure generally relates to a rearview mirror assembly with an electro-optic element and a light sensor that gathers light remote from the electro-optic element for detecting glare.

### SUMMARY OF THE DISCLOSURE

According to one aspect of the present disclosure, a rearview mirror assembly includes an assembly housing and a connection member extending from a first end coupled to the assembly housing and a second end configured to be coupled to a vehicle interior. An optical stack is coupled to the assembly housing and includes an electro-optic element configured to switch between a substantially transmissive state and a substantially darkened state based on an applied voltage. A printed circuit board (“PCB”) is located within the connection member and in conductive communication with the electro-optic element for selectively transmitting the applied voltage. The rearview mirror assembly further includes a first light sensor and a light guide pipe. The light guide pipe includes a first guide end located in the assembly housing and proximate the optical stack and a second guide end located proximate the first light sensor, and the light guide pipe extends at least partially through the connection member.

According to another aspect of the present disclosure, a rearview mirror assembly includes an assembly housing and a connection member that includes a vehicle mounting portion configured to be coupled to a vehicle interior and a mirror mounting portion configured to be coupled to the assembly housing. An optical stack is coupled to the assembly housing and includes an electro-optic element configured to switch between a substantially transmissive state and a substantially darkened state based on an applied voltage. A printed circuit board (“PCB”) is in conductive communication with the electro-optic element for selectively transmitting the applied voltage. The rearview mirror assembly further includes a first light sensor and an optical element. The optical element is coupled to the mirror mounting portion configured to gather light for the first light sensor.

According to yet another aspect of the present disclosure, a rearview mirror assembly includes an assembly housing and a connection member extending from a first end coupled to the assembly housing and a second end configured to be coupled to a vehicle interior. An optical stack is coupled to the assembly housing and includes an electro-active element configured to switch between transmission states based on an applied voltage A printed circuit board (“PCB”) is located within the connection member and in conductive communication with the electro-optic element for selectively transmitting the applied voltage. The PCB includes a front surface facing generally towards the optical stack and a rear surface facing generally away from the optical stack. The rearview mirror assembly further includes a first light sensor is located on the front surface of the PCB and a second light sensor is located on the rear surface of the PCB.

Electro-optic elements are utilized to switch between transmission states dimming and/or scattering light from the environment. These electro-optic elements are sometimes utilized with glare sensing technology. In the case of a rearview mirror assembly, there is limited space within the housing to locate the glare sensing technology and/or to effectively detect the presence of light within the environment. As such, the present disclosure generally relates to a rearview mirror assembly with an electro-optic element and a light sensor that gathers light remote from the electro-optic element for detecting glare to improve both packaging constraints and improve glare detection from the environment.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of an interior of a vehicle that includes a rearview mirror assembly, in accordance with an aspect of the present disclosure;

FIG. 2 is a front perspective disassembled view of a rearview mirror assembly, in accordance with an aspect of the present disclosure;

FIG. 3 is a front perspective view of a rearview mirror assembly with an optical stack removed, in accordance with an aspect of the present disclosure;

FIG. 4 is a side cross-sectional view of a rearview mirror assembly, in accordance with an aspect of the present disclosure; and

FIG. 5 is a side cross-sectional view of a rearview mirror assembly of a second construction, in accordance with an aspect of the present disclosure.

### DETAILED DESCRIPTION

The present illustrated embodiments reside primarily in combinations of method steps and apparatus components related to a rearview mirror assembly with an electro-optic element and a light sensor that gathers light remote from the electro-optic element for detecting glare. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

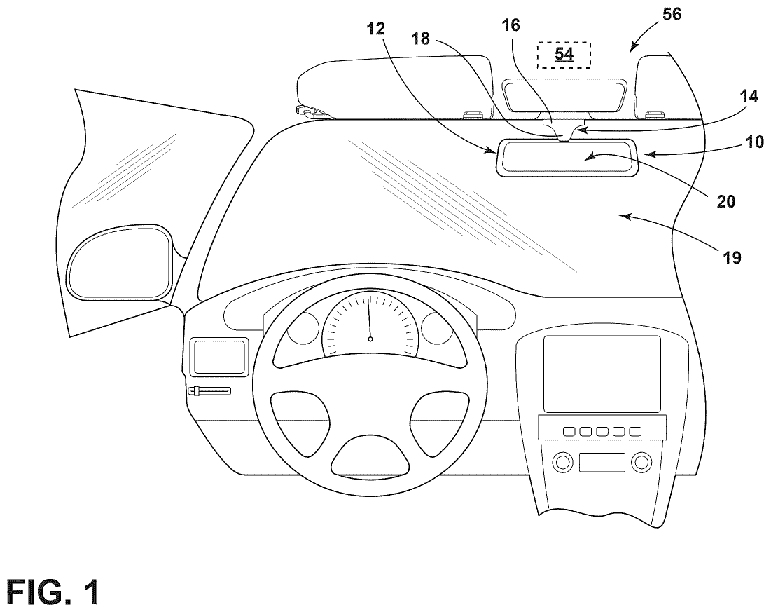

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

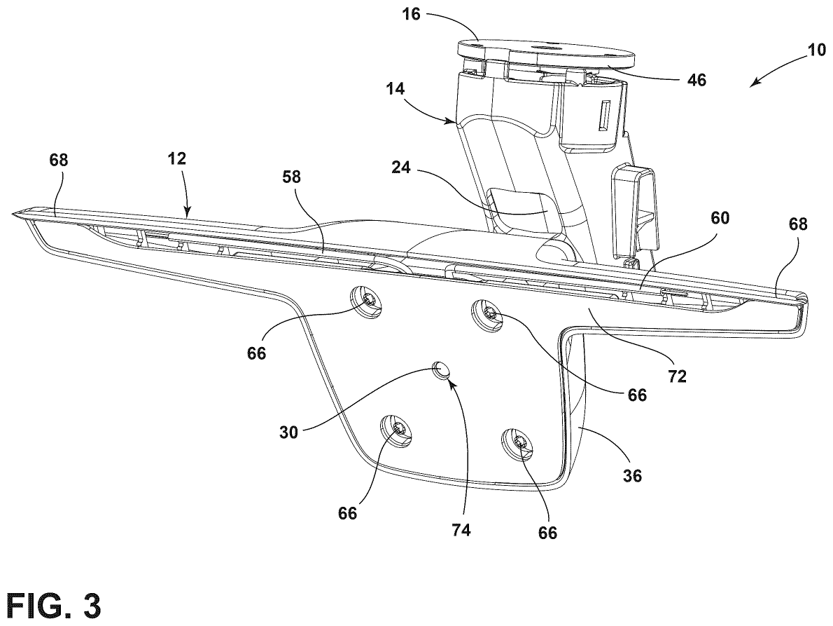

Referring initially to FIGS. 1-4, reference numeral 10 generally designates a rearview mirror assembly. The rearview mirror assembly 10 includes an assembly housing 12 and a connection member 14 extending from a first end 16 coupled to the assembly housing 12 and a second end 18 configured to be coupled to a vehicle interior 19. An optical stack 20 is coupled to the assembly housing 12 and includes an electro-optic element 22 configured to switch between a substantially transmissive state and a substantially darkened state based on an applied voltage. A printed circuit board 24 (“PCB”) located within the connection member 14 and in conductive communication with the electro-optic element 22 for selectively transmitting the applied voltage. The rearview mirror assembly 10 further includes a first light sensor 26 and a light guide pipe 28. The light guide pipe 28 includes a first guide end 30 (FIG. 3) located in the assembly housing 12 and proximate the optical stack 20 and a second guide end 32 located proximate the first light sensor 26, and the light guide pipe 28 extends at least partially through the connection member 14.

As depicted, the optical stack 20 includes an outer perimeter 34, and the assembly housing 12 includes a housing perimeter 36. The outer perimeter 34 of the optical stack may be larger than the housing perimeter 36. More particularly, the assembly housing 12 has a small form factor that provides additional room in the vehicle interior 19 and provides an aesthetically pleasing floating mirror visual to an end user. In order to still permit glare sensing (e.g., from environmental lighting to the rear of the vehicle) with the reduced form factor, the first light sensor 26 may be required to be outside of the assembly housing 12. In this manner, the light guide pipe 28 traverses at least partially through the connection member 14 to the first light sensor 26. More particularly, the first light sensor may be located on the PCB 24 within the connection member 14. In the depicted implementation, the PCB 24 includes a front surface 38 facing generally toward the electro-optic element 22 and a rear surface 40 facing generally away from the electro-optic element 22. In this manner, the first light sensor 26 may be located on the front surface 38 of the PCB 24 for simplicity.

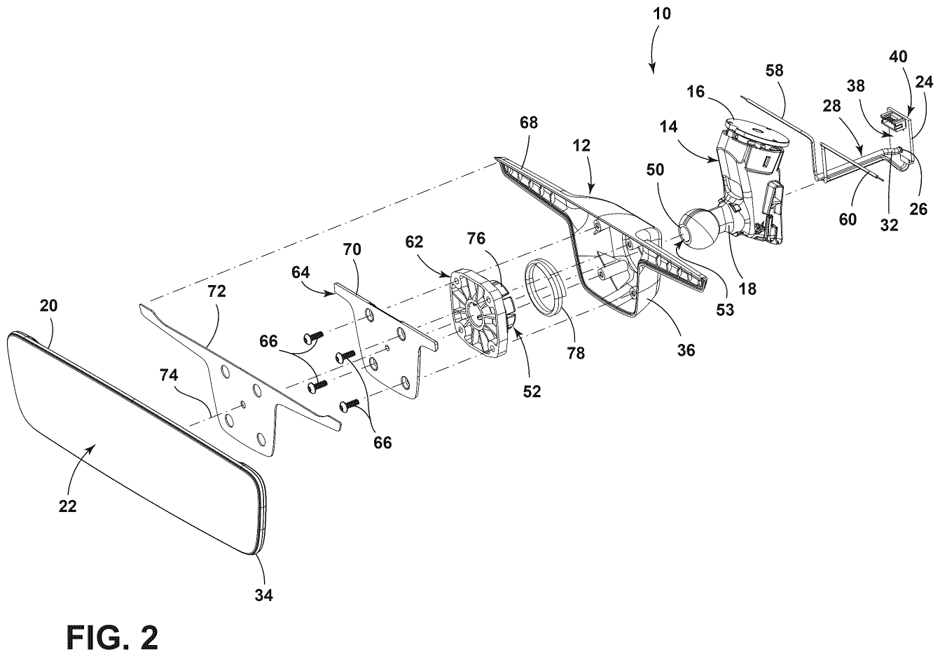

With reference now to FIGS. 2-4, in some implementations, a second light sensor 42 may be located on the PCB 24 for measuring ambient lighting. More particularly, the second light sensor 42 may be located on an opposite side of the PCB 24 than the first light sensor 26 (e.g., the rear surface 40 of the PCB 24). In this manner, the connection member 14 may define an aperture 44 aligned with the second light sensor 42. In such implementations, the first light sensor 26 may be configured to detect illumination directed towards the optical stack 20 and the second light sensor 42 may be configured to detect ambient lighting. In operation, inputs from the first light sensor 26 and the second light sensor 42 may be transmitted to a control system 200 (e.g., located on the PCB 24 and/or in the assembly housing 12) that, in response to detected lighting level thresholds, may automatically apply the applied voltage to the electro-optic element 22. In some embodiments, the amount of applied voltage (e.g., and level of darkening) is directly proportional to the level of detected lighting (e.g., from the first light sensor 26, the second light sensor 42, or both from the first light sensor 26 and the second light sensor 42).

With continued reference to FIGS. 2-4, the connection member 14 may include a vehicle mounting portion 46 and a mirror mounting portion 48. More particularly, the vehicle mounting portion 46 may extend transversely from the mirror mounting portion 48. The vehicle mounting portion 46 and the mirror mounting portion 48 may be integrally formed, otherwise statically coupled, and/or capable of articulating relative to one another. The mirror mounting portion 48 may extend to a ball 50 located within a ball mount cup 52 in the assembly housing 12. The light guide pipe 28 may extend through an opening 53 in the ball 50. In some embodiments, the light guide pipe 28 may extend through (e.g., at least partially or fully) the connection member 14 (e.g., the mirror mounting portion 48 and the vehicle mounting portion 46). In some embodiments, the light guide pipe 28 may extend fully through the mirror mounting portion 48 and partially through the vehicle mounting portion 46. However, it should be appreciated that the first light sensor 26 and/or second light sensor 42 may be positioned in other locations of the rearview mirror assembly 10 or vehicle. For example, the first light sensor 26 and/or second light sensor 42 may be located within a sensor farm 54 located, for example, in an overhead region 56 of the vehicle (FIG. 1). In this manner, the light guide pipe 28 may extend through substantially an entirety of the connection member 14 (e.g., both the mirror mounting portion 48 and the vehicle mounting portion 46) to the sensor farm 54. The sensor farm 54 may generally be defined as a designated region within the vehicle wherein several sensors are packaged for detecting various conditions of the vehicle, the environment, and/or the vehicle interior 19.

The ball 50 and ball mount cup 52 may form a ball joint that allows the assembly housing 12 and the optical stack 20 to be moveable (e.g., tiltable) between a plurality of positions. In this manner, the light guide pipe 28 may generally need to flex between positions between the movement of the assembly housing 12 and the optical stack 20. As such, the light guide pipe 28 may be formed of a flexible material. The second guide end 32 of the light guide pipe 28 may be rigidly fixed relative to the first light sensor 26, and the first guide end 30 may be rigidly fixed relative to the optical stack 20. More particularly, one or more of mechanical harnesses, adhesives, collars (e.g., a conical collar), and/or other fasteners may be utilized to fix the first guide end 30 and the second guide end 32 while the light guide pipe 28 flexes between positions during movement of the assembly housing 12 and the optical stack 20. In some embodiments, the first guide end 30 may be fixed to the optical stack 20 (e.g., directly connected to a rear surface of the optical stack 20). In some embodiments, the first guide end 30 may be fixed in a spaced apart relationship from the optical stack 20.

With reference now specifically to FIGS. 2 and 3, the rearview mirror assembly 10 may include a first EC contact 58 and a second EC contact 60 that transmit the applied voltage to the electro-optic element 22. The first EC contact 58 and the second EC contact 60 may be, for example, flexible wires. The first EC contact 58 and the second EC contact 60 may, likewise, extend through the mirror mounting portion 48 and the vehicle mounting portion 46. In some embodiments, ribs, dividing structures, and/or the like may be located within the mirror mounting portion 48 and the vehicle mounting portion 46 to separate the first EC contact 58 and the second EC contact 60 from the light guide pipe 28.

The rearview mirror assembly 10 may further include other components located within the assembly housing 12. For example, the ball mount cup 52 may include a generally flat rear surface 62 that mounts to a support bracket 64 (e.g., with fasteners 66). The assembly housing 12 may define wings 68 extending in opposite horizontal directions (e.g., in the cross-car direction when installed). The support bracket 64 may, likewise, include support wings 70 that extend at least partially into the wings 68 of the assembly housing 12. A foam or liquid adhesive layer 72 may be located between the optical stack 20 and the support bracket 64. The ball mount cup 52, the support bracket 64, and/or the foam or liquid adhesive layer 72 may, in any combination, define a through hole 74 from which the light guide pipe 28 can extend through. The through hole 74 may include ribs, dividing structures, and/or the like to separate the first EC contact 58 and the second EC contact 60 from the light guide pipe 28. The ball mount cup 52 may include a plurality of spring fingers 76 that snap-fit over the ball 50. A compression spring 78 may extend at least partially over the spring fingers 76 that compress the components of the rearview mirror assembly 10 during assembly.

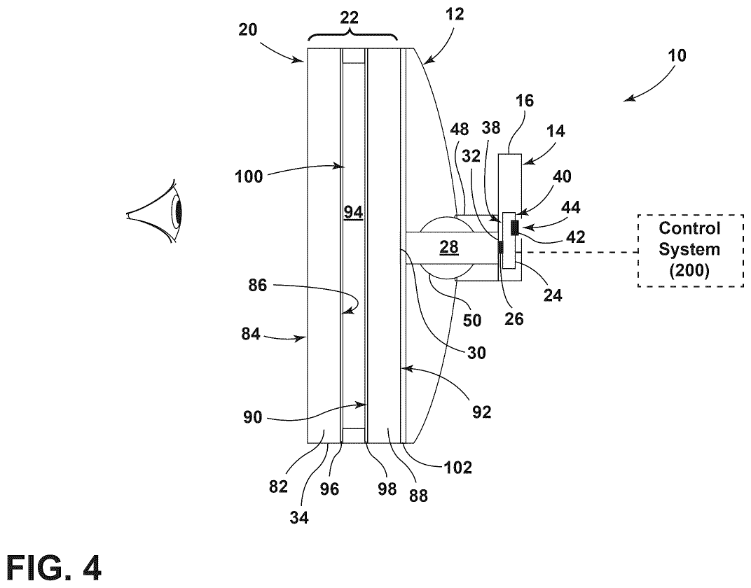

With reference now to FIG. 4, the rearview mirror assembly 10 is schematically depicted. The optical stack 20 may include other components in addition to the electro-optic element 22. For example, the optical stack 20 may include a display element (not shown) for generating graphics and image data from one or more cameras located within the vehicle. In this manner, the rearview mirror assembly 10 may further include a camera located in the assembly housing 12 and a user interface (e.g., touch buttons or screens) for controlling the display element and/or the electro-optic element 22.

In the depicted arrangement, the electro-optic element 22 may include a first substrate 82 having a first surface 84 and a second surface 86 and a second substrate 88 having a third surface 90 and a fourth surface 92. The second substrate 88 is disposed in a substantially spaced apart relationship relative to the first substrate 82 such that the second and third surfaces 86, 90 face one another to define a gap 94. A lower electrode 96 is associated with the second surface 86. An upper electrode 98 is associated with the third surface 90. An electro-optic medium 100 is disposed in the gap 94 between the lower and upper electrodes 96, 98 and configured to switch between a substantially transmissive state and a substantially darkened state. The lower electrode 96 may be in conductive communication with the first EC contact 58 and the upper electrode 98 may be in conductive communication with the second EC contact 60. The applied voltage may have an applied voltage differential. In some embodiments, the applied voltage differential is 12V or less, 8V or less, 6V or less, or about 5V.

The electro-optic medium 100 may include at least one solvent, at least one anodic material, and at least one cathodic material. Typically, both of the anodic and cathodic materials are electroactive and at least one of them may be electrochromic. It will be understood that regardless of its ordinary meaning, the term “electroactive” will be defined herein as a material that undergoes a modification in its oxidation state upon exposure to a particular electric potential difference. Additionally, it will be understood that the term “electro-optic” will be defined herein, regardless of its ordinary meaning, as a material that exhibits a change in its extinction coefficient at one or more wavelengths upon exposure to a particular electric potential difference. Electro-optic components, as described herein, include materials whose color, reflectivity, polarization, phase, or absorbance are affected by an applied voltage differential. The electro-optic components as disclosed herein may be a single-layer, single-phase component, multi-layer component, a solution phase electrochromic system, or multi-phase component. While not explicitly depicted, it should be appreciated that other types of electro-optic devices may be incorporated in the optical stack 20. For example, the electro-optic medium may include a solvent (e.g., solid state, gel, or liquid) sandwiched between an anodic film and a cathodic film. The anodic film and the cathodic film both energized through one of the lower and upper electrodes 96, 98. In other implementations, the electro-optic element 22 may include a liquid crystal medium and/or other electro-active technologies. In some implementations the optical stack 20 may include a reflective layer 102 that may be located behind the electro-optic element 22 (e.g., between the electro-optic element 22 and a display element). The reflective layer 102 may include a traditional mirror finish that always reflects or may be a dynamic or transflective type layer (e.g., an electro-active transflective layer) that is selectively switchable between a reflective state (e.g., to operate as a mirror) or a transmissive state (e.g., to see a rearwardly located display element).

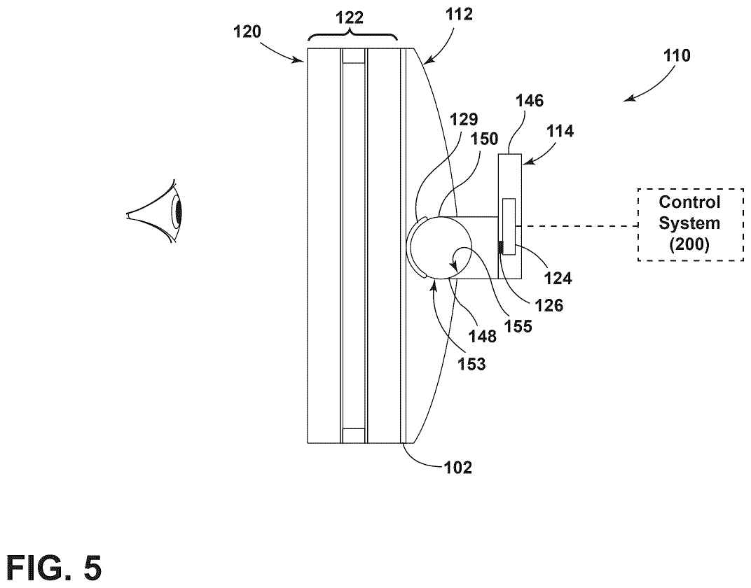

With reference now to FIG. 5, a rearview mirror assembly 110 is depicted in accordance with a second construction. Unless otherwise explicitly stated, the rearview mirror assembly 110 may include all the same components, sizes, functionalities, structures, and materials as the rearview mirror assembly 10 depicted in FIGS. 1-4. However, the rearview mirror assembly 110 of the second construction may not utilize the light guide pipe 28. More particularly, the rearview mirror assembly 110 includes an assembly housing 112 and a connection member 114 that includes a vehicle mounting portion 146 configured to be coupled to the vehicle interior 19 and a mirror mounting portion 148 configured to be coupled to the assembly housing 112. An optical stack 120 is coupled to the assembly housing 112 and includes an electro-optic element 122 configured to switch between a substantially transmissive state and a substantially darkened state based on an applied voltage. A printed circuit board (“PCB 124”) is in conductive communication with the electro-optic element 122 for selectively transmitting the applied voltage. The rearview mirror assembly 110 further includes a first light sensor 126 and an optical element 129. The optical element 129 is coupled to the mirror mounting portion 148 configured to gather light for the first light sensor 126.

With continued reference to FIG. 5, the mirror mounting portion 148 extends to a ball 150 located within a ball mount cup (e.g., similar to or the same as ball mount cup 52 in FIG. 2) in the assembly housing 112. The ball 150 may include an exterior surface 153 at least partially defined by the optical element 129 and an interior surface 155 that receives illumination through the optical element 129. For example, the optical element 129 may include a lens with one or more optical structures (e.g., concave or convex curvatures, optical pillows, parabolic structures, and/or the like). The optical element 129 may be integrally formed and or otherwise coupled with the ball 150 (e.g., an opening within the ball 150). Similar to the rearview mirror assembly 10, the PCB 124 may be located in the connection member 114 and the first light sensor 126 may be located on the PCB 124 and aligned with the mirror mounting portion 148 (e.g., through the mirror mounting portion 148). However, in some embodiments, a light guide pipe 28 may be incorporated into the rearview mirror assembly 110. More particularly, the light guide pipe 28 may include a first guide end 30 located in the assembly housing 112 and proximate the optical element 129 and a second guide end 32 located proximate the first light sensor 126. Similar to the first construction, it should be appreciated that the first light sensor 126 and/or a second light sensor 42 may be positioned in other locations of the rearview mirror assembly 110 or vehicle, alternatively or in addition to the depicted locations. For example, the first light sensor 126 and/or second light sensor 42 may be located within a sensor farm 54 located, for example, in the overhead region 56 of the vehicle (FIG. 1). In this manner, the light guide pipe 28 may extend through substantially an entirety of the connection member 114 (e.g., both the mirror mounting portion 148 and the vehicle mounting portion 146) to the sensor farm 54. In some embodiments, the optical element 129 may be configured to focus light into the first guide end 30.

The disclosure herein is further summarized in the following paragraphs and is further characterized by combinations of any and all of the various aspects described therein.

According to one aspect of the present disclosure, a rearview mirror assembly includes an assembly housing and a connection member extending from a first end coupled to the assembly housing and a second end configured to be coupled to a vehicle interior. An optical stack is coupled to the assembly housing and includes an electro-optic element configured to switch between a substantially transmissive state and a substantially darkened state based on an applied voltage. A printed circuit board (“PCB”) is located within the connection member and in conductive communication with the electro-optic element for selectively transmitting the applied voltage. The rearview mirror assembly further includes a first light sensor and a light guide pipe. The light guide pipe includes a first guide end located in the assembly housing and proximate the optical stack and a second guide end located proximate the first light sensor, and the light guide pipe extends at least partially through the connection member.

According to another aspect, the first light sensor is located on the PCB.

According to yet another aspect, the PCB includes a front surface facing generally towards the electro-optic element and a rear surface facing generally away from the electro-optic element.

According to still another aspect, the first light sensor is located on the front surface of the PCB.

According to another aspect, a second light sensor is located on the rear surface of the PCB, and the connection member for the rearview mirror assembly defines an aperture aligned with the second light sensor.

According to yet another aspect, the first light sensor is configured to detect illumination directed towards the optical stack and the second light sensor is configured to detect ambient lighting.

According to still another aspect, the light guide pipe is formed of a flexible material.

According to still yet another aspect, the connection member includes a vehicle mounting portion and a mirror mounting portion, the mirror mounting portion extending to a ball located within a ball mount cup in the assembly housing.

According to another aspect, the light guide pipe extends through an opening in the ball.

According to yet another aspect, the light guide pipe extends through the mirror mounting portion and the vehicle mounting portion.

According to still another aspect, the first light sensor is configured to be located on a sensor farm within a vehicle body.

According to another aspect of the present disclosure, a rearview mirror assembly includes an assembly housing and a connection member that includes a vehicle mounting portion configured to be coupled to a vehicle interior and a mirror mounting portion configured to be coupled to the assembly housing. An optical stack is coupled to the assembly housing and includes an electro-optic element configured to switch between a substantially transmissive state and a substantially darkened state based on an applied voltage. A printed circuit board (“PCB”) is in conductive communication with the electro-optic element for selectively transmitting the applied voltage. The rearview mirror assembly further includes a first light sensor and an optical element. The optical element is coupled to the mirror mounting portion configured to gather light for the first light sensor.

According to another aspect, the mirror mounting portion extends to a ball located within a ball mount cup in the assembly housing, the ball including an exterior surface at least partially defined by the optical element and an interior surface that receives illumination through the optical element.

According to yet another aspect, the optical element includes a lens.

According to still another aspect, the PCB is located in the connection member.

According to another aspect, the first light sensor is located on the PCB and aligned with the mirror mounting portion.

According to yet another aspect of the present disclosure, a rearview mirror assembly includes an assembly housing and a connection member extending from a first end coupled to the assembly housing and a second end configured to be coupled to a vehicle interior. An optical stack is coupled to the assembly housing and includes an electro-active element configured to switch between transmission states based on an applied voltage A printed circuit board (“PCB”) is located within the connection member and in conductive communication with the electro-optic element for selectively transmitting the applied voltage. The PCB includes a front surface facing generally towards the optical stack and a rear surface facing generally away from the optical stack. The rearview mirror assembly further includes a first light sensor is located on the front surface of the PCB and a second light sensor is located on the rear surface of the PCB.

According to another aspect, the connection member defines an aperture aligned with the second light sensor.

According to yet another aspect, the first light sensor is spaced from the optical stack.

According to still yet another aspect, a rearview mirror assembly includes a light guide pipe including a first guide end located in the assembly housing and proximate the optical stack and a second guide end located proximate the first light sensor.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A rearview mirror assembly, comprising:
an assembly housing;
a connection member extending from a first end coupled to the assembly housing and a second end configured to be coupled to a vehicle interior;
an optical stack coupled to the assembly housing and including an electro-optic element configured to switch between a substantially transmissive state and a substantially darkened state based on an applied voltage;
a printed circuit board (“PCB”) located within the connection member and in conductive communication with the electro-optic element for selectively transmitting the applied voltage;
a first light sensor; and
a light guide pipe including a first guide end located in the assembly housing and proximate the optical stack and a second guide end located proximate the first light sensor, the light guide pipe extending at least partially through the connection member.

2. The rearview mirror assembly of claim 1, wherein the first light sensor is located on the PCB.

3. The rearview mirror assembly of claim 1, wherein the PCB includes a front surface facing generally towards the electro-optic element and a rear surface facing generally away from the electro-optic element.

4. The rearview mirror assembly of claim 3, wherein the first light sensor is located on the front surface of the PCB.

5. The rearview mirror assembly of claim 4, further including a second light sensor located on the rear surface of the PCB, the connection member defining an aperture aligned with the second light sensor.

6. The rearview mirror assembly of claim 5, wherein the first light sensor is configured to detect illumination directed towards the optical stack and the second light sensor is configured to detect ambient lighting.

7. The rearview mirror assembly of claim 1, wherein the light guide pipe is formed of a flexible material.

8. The rearview mirror assembly of claim 7, wherein the connection member includes a vehicle mounting portion and a mirror mounting portion, the mirror mounting portion extending to a ball located within a ball mount cup in the assembly housing.

9. The rearview mirror assembly of claim 8, wherein the light guide pipe extends through an opening in the ball.

10. The rearview mirror assembly of claim 8, wherein the light guide pipe extends through the mirror mounting portion and the vehicle mounting portion.

11. The rearview mirror assembly of claim 10, wherein the first light sensor is configured to be located on a sensor farm within a vehicle body.

12. A rearview mirror assembly, comprising:
an assembly housing;
a connection member includes a vehicle mounting portion configured to be coupled to a vehicle interior and a mirror mounting portion configured to be coupled to the assembly housing;
an optical stack coupled to the assembly housing and including an electro-optic element configured to switch between a substantially transmissive state and a substantially darkened state based on an applied voltage;
a printed circuit board (“PCB”) in conductive communication with the electro-optic element for selectively transmitting the applied voltage;
a first light sensor; and
an optical element coupled to the mirror mounting portion configured to gather light for the first light sensor.

13. The rearview mirror assembly of claim 12, wherein the mirror mounting portion extends to a ball located within a ball mount cup in the assembly housing, the ball including an exterior surface at least partially defined by the optical element and an interior surface that receives illumination through the optical element.

14. The rearview mirror assembly of claim 13, wherein the optical element includes a lens.

15. The rearview mirror assembly of claim 12, wherein the PCB is located in the connection member.

16. The rearview mirror assembly of claim 15, wherein the first light sensor is located on the PCB and aligned with the mirror mounting portion.

17. A rearview mirror assembly, comprising:
an assembly housing;
a connection member extending from a first end coupled to the assembly housing and a second end configured to be coupled to a vehicle interior;
an optical stack coupled to the assembly housing and including an electro-active element configured to switch between transmission states based on an applied voltage;
a printed circuit board (“PCB”) located within the connection member and in conductive communication with the electro-optic element for selectively transmitting the applied voltage, the PCB including a front surface facing generally towards the optical stack and a rear surface facing generally away from the optical stack; and
a first light sensor is located on the front surface of the PCB and a second light sensor is located on the rear surface of the PCB.

18. The rearview mirror assembly of claim 17, wherein the connection member defines an aperture aligned with the second light sensor.

19. The rearview mirror assembly of claim 17, wherein the first light sensor is spaced from the optical stack.

20. The rearview mirror assembly of claim 19, further including a light guide pipe including a first guide end located in the assembly housing and proximate the optical stack and a second guide end located proximate the first light sensor.
